(19) United States
(12) Patent Application Publication
(10) Pub. No.: US 2003/0051150 A1
(43) Pub. Date: Mar. 13, 2003

(54) Method for encrypting multimedia data

(76) Inventor: Jin Ho Jung, Seoul (KR)

Correspondence Address: CANTOR COLBURN, LLP, 55 GRIFFIN ROAD SOUTH, BLOOMFIELD, CT, 06002

(21) Appl. No.: 10/241,288

(22) Filed: Sep. 10, 2002

(30) Foreign Application Priority Data
Sep. 10, 2001 (KR) 2001-55592

(51) Int. Cl. H04L 9/32

(52) U.S. Cl. 713/189

(57) ABSTRACT

The present invention discloses a method for encrypting multimedia data using fingerprint.

In accordance with the preferred embodiment of the present invention, the fingerprint is computed using a data unit that is produced by dividing the multimedia data into a plurality of units as well as another data unit associated with the data unit in a predetermined formula or another fingerprint value corresponding the another data unit in a predetermined formula.

Accordingly, modification of the multimedia data is easily detected as well as such modification becomes so difficult.

### BACKGROUND OF THE INVENTION

1. Field of the Invention

The present invention relates to a method for encrypting multimedia data input from a digital video recorder (DVR), more particularly to the method for encrypting the multimedia data by storing fingerprint values separately from the multimedia data, so that modification of the multimedia data becomes difficult and complicated, and a recipient of the multimedia data is able to easily detect whether the multimedia data is modified.

2. Description of the Related Art

In general, a video tape recorder (VTR) is a device to record analog data that is acquired using a camera into a tape. Unlike the VTR, the VDR is a device capable of recording, storing and transmitting digitalized multimedia data comprised of digital signals generated by converting the analog data.

The digitalized multimedia data is usually compressed using motion image compression technique to reduce a data size before being stored or in a storage device by the VDR or transmitted. Further, the compressed data usually has a kind of encryption characteristic to protect the stored or transmitted multimedia data from being modified.

The multimedia data is encrypted by adding fingerprint to data units in which the data unit is a part of the multimedia data and produced by dividing the multimedia data into a plurality of units for convenience of storing the multimedia data.

As well known in the art, the fingerprint has fixed length and used for detecting whether the multimedia data is modified. Hash function has been proposed to produce the fingerprint. Hash function receives a string as an input and outputs fixed length of bits, so that the fingerprint, output value of the hash function, has a fixed length. The feature of the hash function resides in that the input data may not be predicted using the output of the hash function.

That is, in case of inputting the same input data into the hash function, the output of the hash function is always the same. However, even a character out of the input data (the string) is changed, output of the hash function is changed. Accordingly, it is easily detected whether the data is modified due to such characteristic of the hash function.

Accordingly, the hash function has been used for ensuring security of digital signature and message authentication code because the hash function perfectly protect the data (digital signature and message authentication code) from being modified by a third party.

A message digest 5 (MD5) algorithm designed for fast implementation of software is usually used as such hash function.

In conventional encryption method, the fingerprint is generated by being associated with only a corresponding data unit such as a frame or a field in video data, and a predetermined interval in audio data. Accordingly, the fingerprint can be easily recomputed when a method for computing the fingerprint is leaked because the method of computing the fingerprint is simple.

Therefore, the conventional method involves a problem that it cannot be detected whether the multimedia data is modified in case that the method for computing the fingerprint is leaked and then the multimedia data is modified and re-encrypted using the recomputed fingerprint. Therefore, substantial purpose of the encryption cannot be achieved.

### SUMMARY OF THE INVENTION

It is therefore an object of the present invention to provide a method for encrypting multimedia data using a fingerprint that is computed using a corresponding data unit and a fingerprint value associated with a previous fingerprint in a predetermined formula, so that modification of the multimedia data is easily detected as well as the modification becomes so difficult.

In accordance with one embodiment of the present invention, there is provided a method for encrypting multimedia data, comprising: dividing the multimedia data into a plurality of data units; and computing a fingerprint value for each of the data units, wherein the fingerprint value corresponding to a selected data unit out of the data units is computed using at least one among the selected data unit, another fingerprint value associated with the selected data unit in a predetermined formula, and another data unit associated with the selected data unit in a predetermined formula.

The another fingerprint value is a fingerprint value corresponding to a previous data unit to the selected data unit or a fingerprint value corresponding to a subsequent data unit to the selection data unit.

The fingerprint value corresponding to the selected data unit comprises a forward direction fingerprint value and a backward direction fingerprint value, in which the forward direction fingerprint value corresponding to the selected data unit is generated using the selected data unit and the another forward direction fingerprint value associated with the selected data unit in a predetermined formula, and the backward direction fingerprint value is generated using the selected data unit, the forward direction fingerprint value corresponding to the selected data unit and another backward direction fingerprint value associated with the selected data unit in a predetermined formula.

The another forward direction fingerprint value is a fingerprint value corresponding to a previous data unit to the selected data unit, and the another backward fingerprint value is a fingerprint value corresponding to a subsequent data unit to the selected data unit.

These and other aspects, factors, and advantages of the present invention will become apparent from the following detailed description of preferred embodiments, which is to be read in conjunction with the accompanying drawings.

### BRIEF DESCRIPTION OF THE DRAWINGS

For more complete understanding of the present invention and the advantages thereof, reference is now made to the following descriptions taken in conjunction with the accompanying drawings, in which like reference numerals denote like parts, and in which:

FIG. 1 is a schematic block diagram for showing a method of generating fingerprint used for encrypting the multimedia data in accordance with a first embodiment of the present invention;

FIG. 2 is a flow chart for showing a method for generating the fingerprint shown in FIG. 1;

FIG. 3 is a schematic block diagram for showing a method of generating fingerprint used for encrypting the multimedia data in accordance with second embodiment of the present invention; and

FIG. 4 is a flow chart for showing a method for generating the fingerprint shown in FIG. 3.

### DETAILED DESCRIPTION OF PREFERRED EMBODIMENTS

In the whole drawings, like references denote like elements.

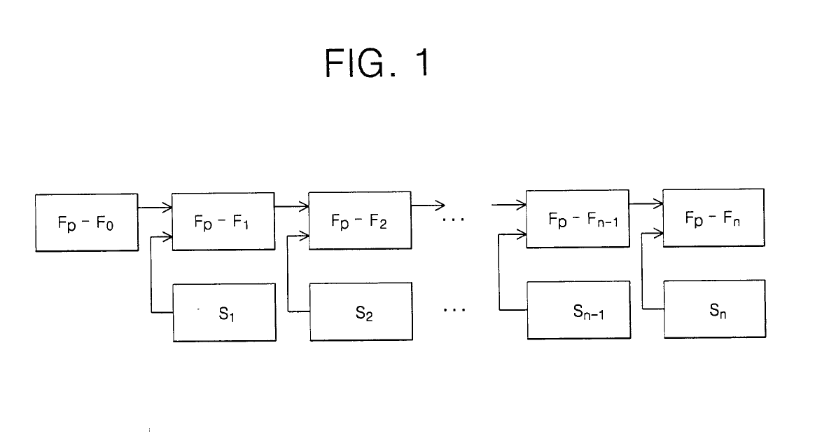

FIG. 1 is a block diagram showing a method of generating fingerprint used for encrypting multimedia data in accordance with a first embodiment of the present invention. As shown in FIG. 1, the multimedia data to be encrypted is divided into a plurality of data units S(1)-S(n). Each of fingerprint values FP_F(1)-FP_F(n) is a fingerprint corresponding to data units S(1)-S(n), respectively. The fingerprint value FP_F(i) is produced by computing a data section S(i) and the preceding fingerprint value FP_F(i−1) corresponding to the preceding data unit S(i−1).

The a data unit S(i) (i=1, 2, 3 . . . , n) may be a frame or a field when the multimedia data is a video file or an image file, and be a predetermined interval in case of an audio file.

In case of producing the multimedia data in real time, the data unit may not be generated preliminarily but produced in real time too.

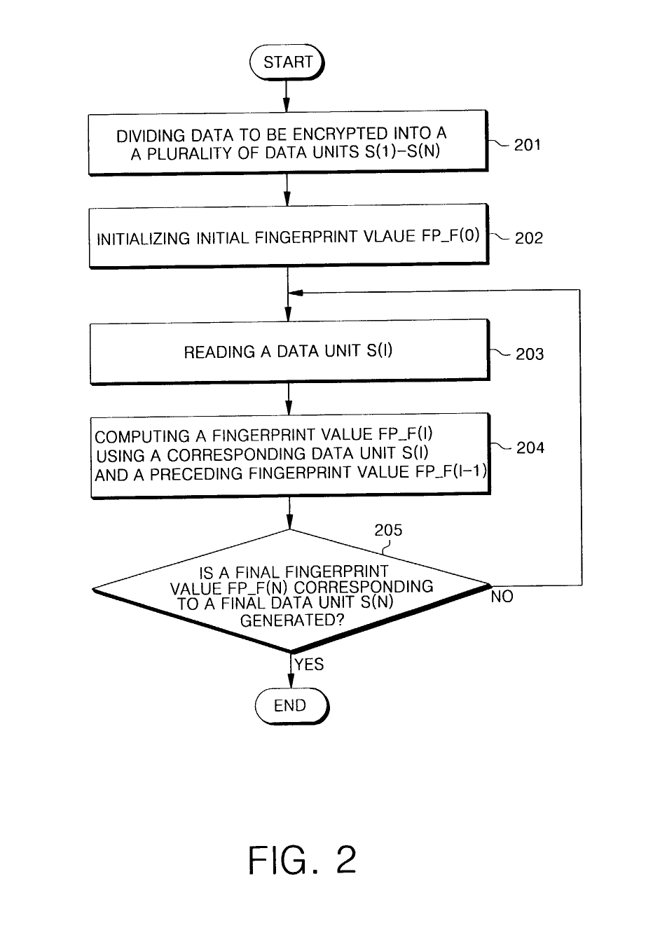

FIG. 2 is a flow chart for showing a method for generating the fingerprint shown in FIG. 1.

First, the multimedia data to be encrypted is divided into a plurality of data units S(1)-S(n) (Step 201), and a forward direction initial fingerprint value FP_F(0) is initialized. (Step 202)

Next, a data unit S(i) is read in ascending order. (Step 203).

Next, the fingerprint value FP_F(i) corresponding to the data unit S(i) read out in step 203 is generated by computing the corresponding data unit S(i) and the preceding fingerprint value FP_F(i−1) corresponding to the preceding data unit S(i−1). For example, when the i equals to 1, a first fingerprint value FP_F(1) is generated by computing a first data unit S(1) with the initial fingerprint value FP_F(0). Further, when the i equals to 2, a second fingerprint value FP_F(2) is generated by computing a second data unit S(2) with the first fingerprint value FP_F(1) corresponding to the first data unit S(1). The generated fingerprint value FP_F(i) is stored separately from the data unit. (Step 204)

Next, it is determined whether the forward direction fingerprint value FP_F(i) generated during step 204 is a final forward direction fingerprint value FP_F(n). In case of not being the final forward direction fingerprint value FP_F(n), the steps S203-S205 are repeated till the final forward direction fingerprint value FP_F(n) is generated. On the other hand, in case of being the final forward direction fingerprint value FP-F(n), operation of generating forward direction fingerprint value is ended.

Since the fingerprint is computed in a way discussed above, in case of modifying content of the first data unit S(i), it is therefore required to modify the corresponding fingerprint value FP_F(i) too. Also, it is further required to modify the subsequent fingerprint value FP_F(i+1) corresponding to the subsequent data unit S(i+1) because the modified corresponding fingerprint value FP_F(i) affects the subsequent fingerprint value FP_F(i+1). As the same way, all of the subsequent fingerprint values FP_F(i+2)-FP_F(n) corresponding to the subsequent data units S(i+2)-S(n) should be modified because every preceding fingerprint value is associated with the subsequent fingerprint values.

Therefore, it is difficult to modify the content of the data unit without being detected by a recipient of the multimedia data because computation of the fingerprint values is so complicated and every fingerprint values are associated with each other.

In the first embodiment of the present invention, each of the fingerprint values is computed using a data unit and the preceding fingerprint value, so that modification of the content of the data unit becomes difficult. The method shown in FIG. 1 is not limited thereto but may be implemented with various modifications.

For example, (i−2)^{th} or (i−3)^{th} previous fingerprint value corresponding to (i−2)^{th} or (i−3)^{th} previous data unit to the corresponding data unit S(i) may be used to compute the corresponding fingerprint value FP_F(i). Further, all of previous fingerprint values FP_F(0)-FP_F(i−1) to the fingerprint value FP_F(i) may be used as an input to generate the instant fingerprint value FP_F(i).

Further, the fingerprint value FP-F(i) corresponding to the data unit S(i) may be computed in different formula. For example, every even numbered fingerprint value FP_F(2i) corresponding to every even numbered data unit S(2i) may be computed using the preceding fingerprint value FP_F(i−1) to the fingerprint value FP_F(2i), while every odd numbered fingerprint value FP_F(2i−1) corresponding to the every odd numbered data unit S(2i−1) may be generated using an (i−2)^{th} previous fingerprint value FP_F(i−2) to the fingerprint value FP_F(2i−1).

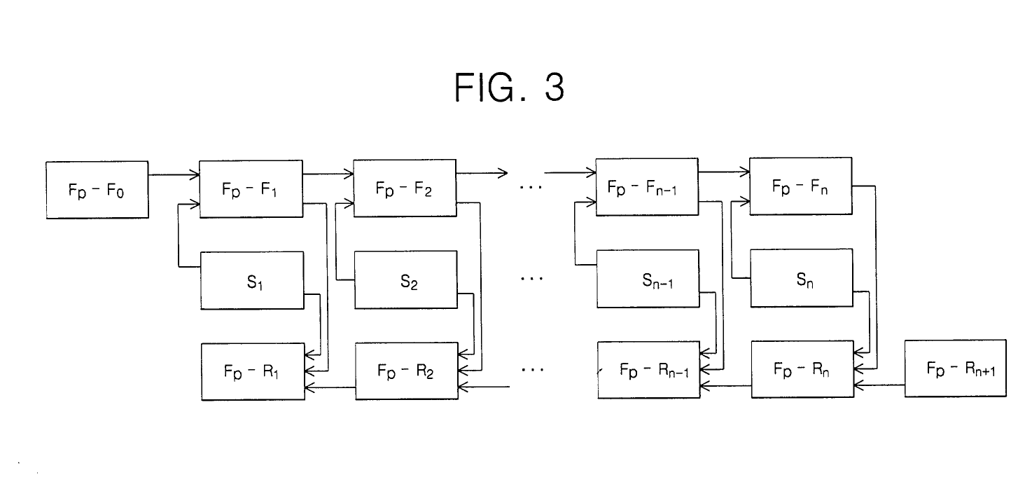

FIG. 3 is a block diagram showing a method of generating fingerprint in accordance with second embodiment of the present invention.

As shown in FIG. 3, to generate the fingerprint, there is provided a multimedia data divided into a plurality of data units S(1)-S(n). The fingerprint is comprised of a plurality of forward direction fingerprint values FP_F(1)-FP_F(n) corresponding to the data units S(1)-S(n), respectively and backward direction fingerprint values FP_R(1)-FP-R(n) corresponding to the data units S(1)-S(n), respectively. The fingerprint value FP_FP(0) is a forward direction initial value to generate the forward direction fingerprint values FP_F(1)-FP_F(n) and the fingerprint value FP R(n+1) is a backward direction initial value for generating the backward direction fingerprint values FP_R(1)-FP-R(n).

To generate an (i)^{th} fingerprint value corresponding to an (i)^{th} data unit, the previous fingerprint values corresponding to the previous data units, respectively, as well as the subsequent fingerprint values corresponding to the subsequent data units, respectively, may be used, so that modification of the content of a data unit becomes more complicated and difficult than the fingerprint generated in accordance with the first embodiment of the present invention.

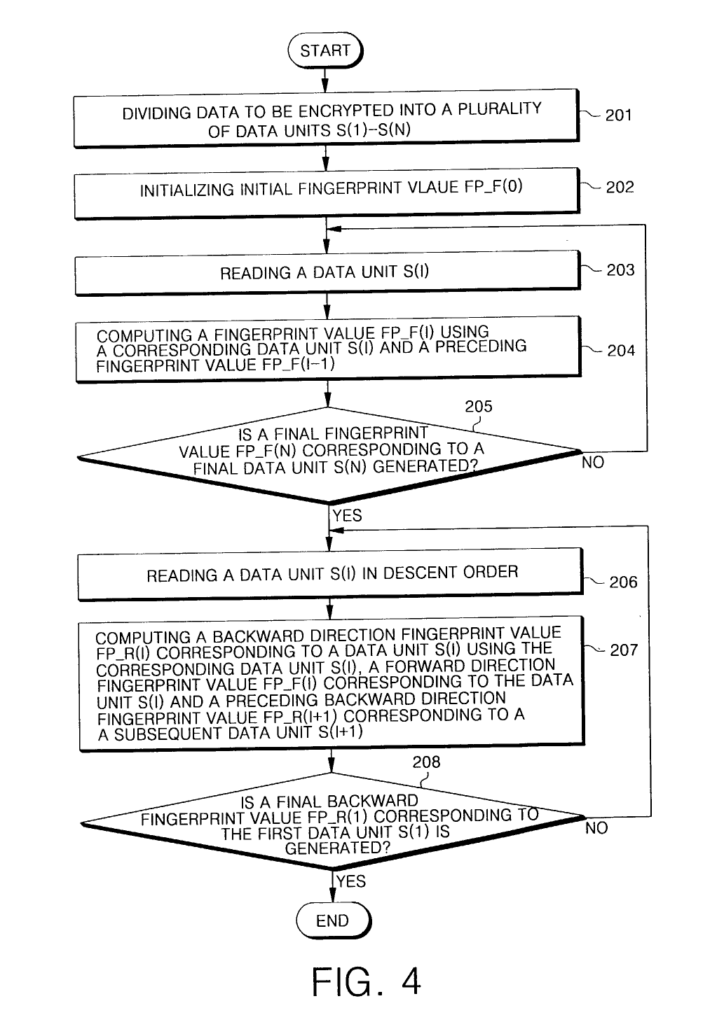

The fingerprint in accordance with the second embodiment of the present invention will be generated as shown in FIG. 4.

First, multimedia data is divided into a plurality of data units S(1)-S(n). (Step 201)

Next, a forward direction initial value FP_F(0) for generating forward direction fingerprint values FP_F(1)-FP_F(n) corresponding to data units S(1)-S(n), respectively, is initialized. (Step 202)

Next, data units S(i) are read out in ascending order. (Step 203)

Next, a forward direction fingerprint value FP_F(i) corresponding to the data unit S(i) is computed using the preceding forward direction fingerprint value FP_F(i−1) and the corresponding data unit S(i), and then the computed forward direction fingerprint value FP_F(i) is stored. (Step 204)

That is, when i equals to 1, a forward direction first fingerprint value FP_F(1) is generated using a first data unit S(1) and the initial fingerprint value FP_F(0). When i equals to 2, a second forward direction fingerprint value FP_F(2) is generated using a second data unit S(2) and the forward direction first fingerprint value FP_F(1).

Next, it is determined whether the forward direction fingerprint value FP_F(i) generated during step 204 is a final forward direction fingerprint value FP_F(n). In case of not being the final forward direction fingerprint value FP_F(n), the steps 202-204 are repeated till the final forward direction fingerprint value FP_F(n) is generated. In case of being the final forward direction fingerprint value FP_F(n), operation of generating forward direction fingerprint values FP_F(1)-FP_F(n) is finished. (Step 205)

Next, backward direction initial value FP_R(n+1) is initialized for generating the backward fingerprint values FP_R(n)-FP_R(1).

Next, the data units S(1)-S(n) are read out in reverse (descending) order, i.e. from S(n) to S(1) (Step 206).

Next, operation for generating backward direction fingerprint values FP_R(n)-FP_R(1) corresponding to the data units S(n)-S(1), respectively is implemented in turn and stored. (Step 207)

A backward direction fingerprint value FP_R(i) is computed by receiving a corresponding data unit S(i), a forward direction fingerprint value FP_F(i) corresponding to the data unit S(i) and a preceding backward direction fingerprint value FP_R(i+1) corresponding to the subsequent data unit S(i+1) as input.

Therefore, when i equals to n, a first backward direction fingerprint value FP_R(n) is generated using the final data unit S(n), the final forward direction fingerprint value FP_F(n) corresponding to the final data unit S(n) and the backward direction initial value FP_R(n+1). Further, when i equals to n−1, a second backward direction fingerprint value FP_R(n−1) corresponding to the data unit S(n−1) is generated using the corresponding data unit S(n−1), the forward direction fingerprint value FP_F(n−1) corresponding to the corresponding data unit S(n−1) and the first backward direction fingerprint value FP_R(n) corresponding to the subsequent data unit S(n).

Next, it is determined whether a backward direction fingerprint value generated during step 207 is a final backward direction fingerprint value FP_R(1) corresponding to the first data unit S(1). (Step 208) In case of not being the final backward direction fingerprint value FP_R(1), the steps 206-207 are repeated. In case of being the final backward direction fingerprint value FP_R(1), operation of generating the backward direction fingerprint is finished.

As discussed above, the fingerprint in accordance with the preferred embodiment of the present invention is computed in a complicated way, so that modification of the content of one data unit S(i) is difficult because such modification of even one data unit S(i) affects every subsequent fingerprint values. Therefore, to modify the content of the one data unit S(i) so as the modification not to be detected, the forward direction fingerprint value FP_F(i) corresponding to the modified data unit S(i) as well as every forward direction fingerprint values FP_F(i+1)-FP_F(n) subsequent to the fingerprint value FP_F(i) are modified. It is further needed to modify all of the backward direction fingerprint values FP_R(1)-FP_R(n) too.

Accordingly, it is probably impossible to modify content of one data unit out of the multimedia data as long as every fingerprint value corresponding to every data unit (whole multimedia data) is not modified.

As shown in FIGS. 3 and 4, the backward direction fingerprint value FP_R(i) corresponding to a data unit S(i) is acquired by using the corresponding data unit S(i), the preceding fingerprint value FP_R(i−1) in backward direction and the corresponding forward direction fingerprint value FP_F(i) as input.

Further, a (i+2)^{th} or (i+3)^{th} previous backward direction fingerprint value FP_R(i+2) or FR_R(i+3) may be used instead of the preceding backward fingerprint value FP_R(i+1). Further, a forward direction fingerprint values FP_F(i+1) or FP_F(i+2) may be used instead of the corresponding fingerprint value FP_F(i).

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for encrypting multimedia data, comprising:
dividing the multimedia data into a plurality of data units; and
computing fingerprint values corresponding to each of the data units, respectively,
wherein the fingerprint value corresponding to a selected data unit out of the data units is computed using at least one among the selected data unit, another fingerprint value associated with the selected data unit in a predetermined formula, and another data unit associated with the selected data unit in a predetermined formula.

2. The method according to claim 1, wherein the another fingerprint value is a fingerprint value corresponding to a preceding data unit to the selected data unit or a fingerprint value corresponding to a subsequent data unit to the selection data unit.

3. The method according to claim 1, wherein the fingerprint value corresponding to the selected data unit comprises a forward direction fingerprint value and a backward direction fingerprint value, in which the forward direction fingerprint value is generated using the selected data unit and the another fingerprint value associated with the selected data unit in a predetermined formula, and the backward direction fingerprint value is generated using the selected data unit, the forward direction fingerprint value corresponding to the selected data unit in a predetermined formula and another backward direction fingerprint value associated with the selected data unit in a predetermined formula.

4. The method according to claim 3, wherein the another fingerprint value is a fingerprint value corresponding to a preceding data unit to the selected data unit, and the another backward direction fingerprint value is a fingerprint value corresponding to a subsequent data unit to the selected data unit.
